(19) United States
(12) Patent Application Publication
(10) Pub. No.: US 2025/0360420 A1
(43) Pub. Date: Nov. 27, 2025

(54) VIRTUAL ITEM EQUIPPING METHOD AND APPARATUS FOR, DEVICE, STORAGE MEDIUM, AND PROGRAM PRODUCT

(71) Applicant: Tencent Technology (Zhenzhen) Company Limited, Zhenzhen (CN)

(72) Inventor: Ziqi Wei, Shenzhen (CN)

(21) Appl. No.: 19/295,313

(22) Filed: Aug. 8, 2025

Related U.S. Application Data
(63) Continuation of application No. PCT/CN2024/089285, filed on Apr. 23, 2024.

(30) Foreign Application Priority Data
Jun. 15, 2023 (CN) 202310713781.8

(51) Int. Cl. A63F 13/69; A63F 13/533; A63F 13/822

(52) U.S. Cl. CPC A63F 13/69; A63F 13/533; A63F 13/822

(57) ABSTRACT

This application discloses a virtual item equipping method performed by a computer device. The method includes: displaying at least one virtual chess piece and at least two to-be-equipped virtual items in a game interface of an auto chess game; displaying, in an item multi-option mode, virtual items in a selected state and virtual items in an unselected state among the at least two to-be-equipped virtual items; and in response to an operation of equipping the at least two virtual items in the selected state to a first virtual chess piece of the at least one virtual chess piece, displaying a display effect of the first virtual chess piece being equipped with the at least two virtual items. By using the method, a plurality of virtual items can be equipped to the virtual chess piece through one equipping operation, thereby improving the efficiency of equipping the virtual items.

### CROSS-REFERENCE TO RELATED APPLICATIONS

This application is a continuation application of PCT Patent Application No. PCT/CN2024/089285, entitled “VIRTUAL ITEM EQUIPPING METHOD AND APPARATUS FOR, DEVICE, STORAGE MEDIUM, AND PROGRAM PRODUCT” filed on Apr. 23, 2024, which claims priority to Chinese Patent Application No. 2023107137818, entitled “VIRTUAL ITEM EQUIPPING METHOD AND APPARATUS, DEVICE, AND STORAGE MEDIUM” filed with the China National Intellectual Property Administration on Jun. 15, 2023, both of which are incorporated herein by reference in their entirety.

### FIELD OF THE TECHNOLOGY

Embodiments of this application relate to the field of computer technologies, and in particular, to equipping of virtual items.

### BACKGROUND OF THE DISCLOSURE

In an auto chess game, users (that is, players) may equip virtual items to virtual chess pieces to enhance capabilities of the virtual chess pieces in the game.

In this process, when a user needs to equip a plurality of virtual items to one virtual chess piece, the user needs to first drag and drop one of the plurality of virtual items onto the virtual chess piece to complete the equipping of the virtual item. Then, the remaining virtual items are equipped individually in the same manner, resulting in a complex equipping process, and low operation efficiency.

### SUMMARY

Embodiments of this application provide a virtual item equipping method and apparatus, a device, a storage medium, and a program product, which reduces operation steps and improves the efficiency of equipping the virtual item. Technical solutions provided in the embodiments of this application are as follows:

According to an aspect of the embodiments of this application, a virtual item equipping method is provided. The method includes:
displaying at least one virtual chess piece and N to-be-equipped virtual items in a game interface of an auto chess game, N being greater than 1;
displaying, in an item multi-option mode, virtual items in a selected state and virtual items in an unselected state among the N to-be-equipped virtual items; and
in response to an operation of equipping M virtual items in the selected state to a first virtual chess piece of the at least one virtual chess piece, displaying a display effect of the first virtual chess piece being equipped with the M virtual items, M being greater than 1 and less than and equal to N.

According to an aspect of the embodiments of this application, a computer device is provided. The computer device includes a processor and a memory, the memory having a computer program stored therein, the computer program being loaded and executed by the processor and causing the computer device to implement the foregoing virtual item equipping method.

According to an aspect of the embodiments of this application, a non-transitory computer-readable storage medium is provided. The storage medium has a computer program stored therein, the computer program being loaded and executed by a processor to implement the foregoing virtual item equipping method.

According to an aspect of the embodiments of this application, a computer program product is provided. The computer program product includes a computer program, the computer program being stored in a non-transitory computer-readable storage medium, a processor reading the computer program from the computer-readable storage medium, and executing the computer program, to implement the foregoing virtual item equipping method.

The technical solutions provided in the embodiments of this application include at least the following beneficial effects:

At least one virtual chess piece and N to-be-equipped virtual items are displayed in a game interface of an auto chess game, virtual items in a selected state and virtual items in an unselected state among the virtual items are differentially displayed in an item multi-option mode, and in response to an operation of equipping a plurality of virtual items in the selected state to any virtual chess piece, the virtual chess piece being equipped with M virtual items is displayed. It can be learned that a plurality of virtual items that need to be equipped on a virtual chess piece can be selected in the item multi-option mode, and the selected state and the unselected state of the virtual items are intuitively and accurately reflected in a differential display manner, thereby effectively improving the accuracy of equipping the virtual items. In addition, the plurality of virtual items can be equipped to the virtual chess piece through only one equipping operation, thereby reducing operation steps, and improving the efficiency of equipping the virtual items.

### BRIEF DESCRIPTION OF THE DRAWINGS

FIG. 1 is a schematic diagram of a solution implementation environment according to an embodiment of this application.

FIG. 2 is a flowchart of a virtual item equipping method according to an embodiment of this application.

FIG. 3 is a schematic diagram of a game interface of an auto chess game according to an embodiment of this application.

FIG. 4 is a schematic diagram of different display styles of virtual items according to an embodiment of this application.

FIG. 5 is a schematic diagram of selecting a virtual item according to an embodiment of this application.

FIG. 6 is a schematic diagram of equipping a virtual item according to an embodiment of this application.

FIG. 7 is a schematic diagram of entering an item multi-option mode according to an embodiment of this application.

FIG. 8 is a schematic diagram of a display effect of a virtual chess piece being equipped with a virtual item according to an embodiment of this application.

FIG. 9 is a schematic diagram of an item combination rule according to an embodiment of this application.

FIG. 10 is a schematic diagram of a combined virtual item according to an embodiment of this application.

FIG. 11 is a schematic diagram of equipping a combined virtual item according to an embodiment of this application.

FIG. 12 is a schematic diagram of a display effect of a virtual chess piece being equipped with a combined virtual item according to an embodiment of this application.

FIG. 13 is a schematic diagram of entering an item transfer mode according to an embodiment of this application.

FIG. 14 is a schematic diagram of being in an item transfer mode according to an embodiment of this application.

FIG. 15 is a schematic diagram of performing item transfer between virtual chess pieces according to an embodiment of this application.

FIG. 16 is a schematic diagram of completing item transfer according to an embodiment of this application.

FIG. 17 is a schematic diagram of a virtual detacher according to an embodiment of this application.

FIG. 18 is a block diagram of a specific solution for item equipping in an item multi-option mode according to an embodiment of this application.

FIG. 19 is a block diagram of a specific solution for item transfer between virtual chess pieces in an item transfer mode according to an embodiment of this application.

FIG. 20 is a block diagram of a virtual item equipping apparatus according to an embodiment of this application.

FIG. 21 is a block diagram of a structure of a terminal device according to an embodiment of this application.

### DESCRIPTION OF EMBODIMENTS

To make objectives, technical solutions, and advantages of this application clearer, implementations of this application are further described below in detail with reference to the accompanying drawings.

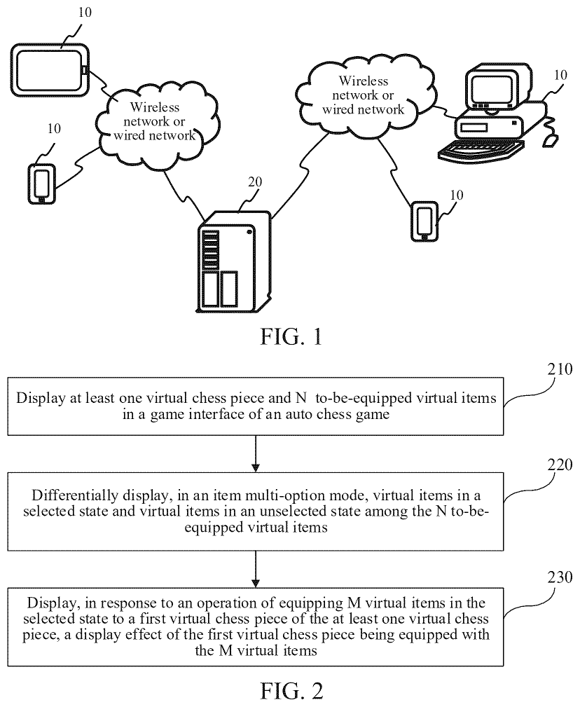

FIG. 1 is a schematic diagram of a solution implementation environment according to an embodiment of this application. The implementation environment may include: a terminal device 10 and a server 20.

The terminal device 10 may be an electronic device such as a mobile phone, a tablet computer, a multimedia playback device, a personal computer (PC), a wearable device, or an in-vehicle terminal. A client running a target application may be installed in the terminal device 10. The target application may be a game application, for example, an auto chess game application, or another application provided with an auto chess game.

The server 20 may be configured to provide a backend service for the client of the target application (for example, the game application) in the terminal device 10. For example, the server 20 may be a backend server of the target application (for example, the game application). The server 20 may be one server, a server cluster including a plurality of servers, or a cloud computing service center.

The terminal device 10 may communicate with the server 20 through a network, for example, a wireless network or a wired network.

In other words, the embodiments of this application may be performed by a computer device. The computer device may be the terminal device or server. When the computer device is the server, the computer device is applicable to a cloud gaming scenario. In this scenario, the server responds to and processes an interaction operation, and the terminal device receiving the interaction operation displays a processing result.

In addition, in the embodiments of this application, an implementation form of the target application is not limited. For example, the target application may be an application that needs to be downloaded and installed, a mini program that does not require installation, a web application, or the like.

FIG. 2 is a flowchart of a virtual item equipping method according to an embodiment of this application. An execution body of operations of the method is exemplified by the terminal device as the computer device. For example, the execution body of the operations may be the client of the target application. The method may include at least one of the following operation 210 to operation 230.

Operation 210: Display at least one virtual chess piece and N to-be-equipped virtual items in a game interface of an auto chess game.

The auto chess game is a multiplayer turn-based competitive game featuring in-match collectible hero cards. A quantity of players may be two or more. In some embodiments, a game has eight users in total, and a user account has initial attribute points. For example, the attribute points may be health points, or may be stamina points. Each user occupies a chessboard. Each round includes two phases: a preparation phase and a combat phase. In the preparation phase, the user strategically arranges virtual chess pieces (also often referred to as “heroes”) on the chessboard. Once the combat phase begins, lineups of both players are locked, and the virtual chess pieces engage in automatic combat until all virtual chess pieces on one side are defeated. The account of the defeated player has attribute points deducted. Players are repeatedly matched against new opponents in consecutive rounds until the attribute points of their user accounts drop to ≤0, resulting in elimination. The last remaining user becomes the winner of the game.

The virtual chess pieces are configured for automatic combat in the auto chess game. In some embodiments, the user may add, remove, or replace the virtual chess pieces that engage in automatic combat in the auto chess game, and the user may further change the positions of the virtual chess pieces in the game interface.

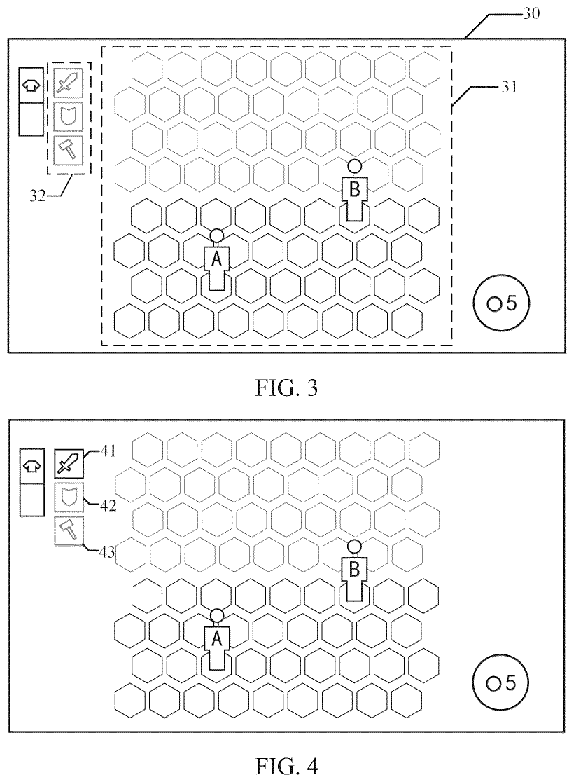

The game interface of the auto chess game is a user interface configured for displaying the virtual chess pieces, the virtual items, and any other game content that may be included in the auto chess game. Referring to FIG. 3, in some embodiments, the game interface of the auto chess game may be a match interface, and the match interface may include a match display area 31 for virtual chess pieces to engage in combat and assemble lineups and an item display area 32 for storing virtual items. Further, the match display area 31 may further include a bench zone (not shown) and a combat zone (not shown). The bench zone is configured for displaying virtual chess pieces owned by the user but not yet deployed, and the combat zone is configured for displaying virtual chess pieces that have been deployed by the user. For example, the bench zone and the combat zone may each display at least one virtual chess piece, and the item display area may display N to-be-equipped virtual items, N being an integer greater than 1. In some embodiments, the game interface of the auto chess game may further be a backpack interface, an in-match store interface, or the like. This is not limited in this application.

The virtual items are equipped to the virtual chess pieces to enhance capabilities of the virtual chess pieces during automatic combat. In some embodiments, equipping the virtual items to the virtual chess pieces can improve corresponding attributes of the virtual chess pieces. For example, equipping a virtual sword to a virtual chess piece can improve attack power of the virtual chess piece, and equipping a virtual shield to a virtual chess piece can improve defense power of the virtual chess piece.

Operation 220: Differentially display, in an item multi-option mode, virtual items in a selected state and virtual items in an unselected state among the N to-be-equipped virtual items.

The item multi-option mode is a mode allowing the user to simultaneously select, combine, or equip a plurality of items to virtual chess pieces.

Whether the virtual items are in the selected state or the unselected state depends on the selection of the user. The user may perform operations such as combination and equipping on the virtual items in the selected state. This is described in detail in the following embodiments.

In the auto chess game, although different virtual items have different icons, this is different from the differential display mentioned in this operation. In this application, the differential display of the virtual items may be understood as the differential display of display styles of the virtual items excluding icons. In some embodiments, differential display may be achieved by changing the background color, brightness, or pattern contours of the virtual items. For example, the background color of the virtual items in the selected state is changed from white to yellow, the virtual items are highlighted, and the pattern contours of the virtual items are bolded. In some other embodiments, differential display may be achieved by adding an additional shape, color, or pattern to the icons of the virtual items. For example, an additional white border is added for the icons of the virtual items in the selected state. How to differentially display the virtual items is not limited in this application.

In some embodiments, in the item multi-option mode, virtual items in the selected state are displayed in a first display style, and virtual items in the unselected state are displayed in a second display style.

The first display style is different from the second display style. The first display style indicates that the corresponding virtual items are in the selected state, and the second display style indicates that the corresponding virtual items are in the unselected state. For example, referring to FIG. 4, a virtual sword 41 in the selected state adopts the first display style, that is, a display style with a dark pattern contour color, and a virtual shield 42 and a virtual hammer 43 in the unselected state adopt the second display style, that is, a display style with a light pattern contour color. In addition, descriptions about specific display forms of the first display style and the second display style in this application are merely exemplary descriptions, and are not limited in this application.

By distinguishing the virtual items based on the first display style and the second display style, it is possible to clearly and intuitively indicate whether the virtual items are in the selected state in the item multi-option mode, thereby improving the operation efficiency.

In some embodiments, in response to an operation on any virtual item in the unselected state, the operated virtual item is switched from the second display style to the first display style, or in response to an operation on any virtual item in the selected state, the operated virtual item is switched from the first display style to the second display style.

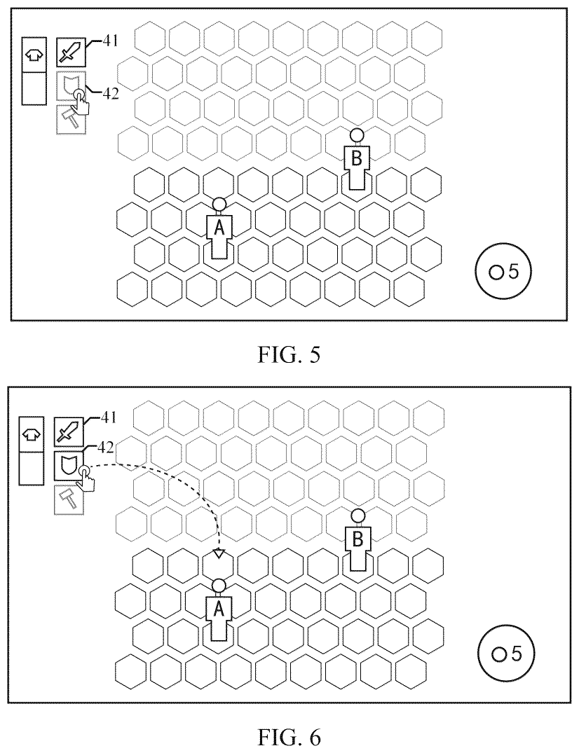

In some embodiments, the operation on any virtual item may be a click operation on any virtual item. For example, referring to FIG. 5 and FIG. 6, in FIG. 5, in response to a click operation on the virtual shield 42 (in the second display style) in the unselected state, the virtual shield 42 may be switched from the second display style to the first display style that is shown by the virtual shield 42 in FIG. 6.

According to the foregoing method, real-time switching of the selection states of the virtual items can be achieved, making the selection process of the virtual items more flexible.

In some embodiments, after operation 210, the foregoing virtual item equipping method further includes:

entering the item multi-option mode in response to a first operation on a first virtual item, and displaying the first virtual item in the first display style, the first virtual item being any to-be-equipped virtual item, and the first operation being an operation configured for triggering to enter the item multi-option mode.

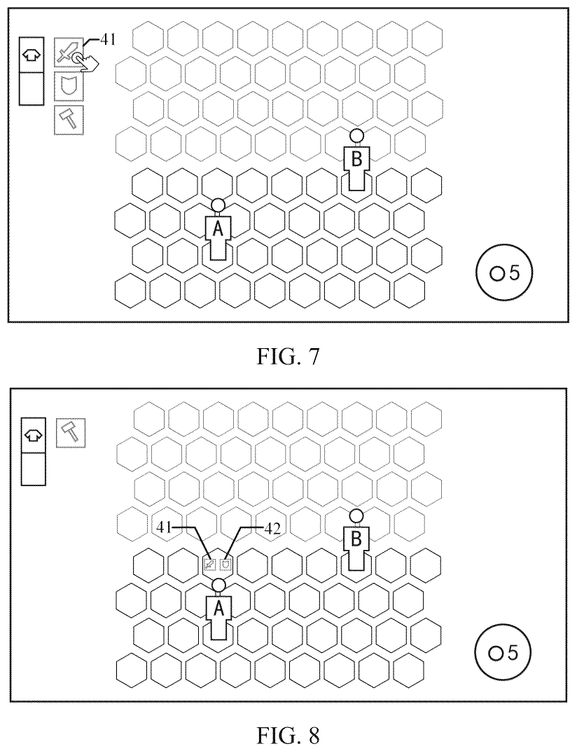

In some embodiments, the first operation may be a long-press operation on the first virtual item. For example, referring to FIG. 4 and FIG. 7, in FIG. 7, in response to a long-press operation on the virtual sword 41, the item multi-option mode may be entered, and the virtual sword 41 is switched from the second display style to the first display style that is shown by the virtual sword 41 in FIG. 4.

The long-press operation is an operation of continuously touching an object for more than a preset time. In some embodiments, technicians may preset a time threshold. For example, the time threshold may be 0.5 seconds or 1 second. When a touch time exceeds the threshold, the touch operation is considered as the long-press operation. The touch and press operation may be performed by the user using a mouse or a stylus, or may be directly performed by a hand. This is not limited in this application.

According to the foregoing method, the first virtual item may be selected when the item multi-option mode is entered, thereby improving the item selection efficiency.

In some other embodiments, the game interface further displays a multi-option mode button, and the item multi-option mode may also be entered in response to an operation on the multi-option mode button. In some embodiment, the operation may be a click operation.

In some embodiments, when the item multi-option mode is not entered, in response to an operation on the first virtual item, corresponding prompt information is displayed to indicate attribute details of the first virtual item. In addition, the operation on the first virtual item herein is different from the first operation. The prompt information may be a pop-up window, or may be directly displayed on an area corresponding to the first virtual item. This is not limited in this application. For example, when the first operation is a long press on the first virtual item, and the item multi-option mode is not entered, in response to a click operation on the first virtual item, corresponding prompt information may be displayed to indicate attribute details of the first virtual item. Further, if the first virtual item is the virtual sword, the prompt information may indicate an attack power value of the virtual sword; or if the first virtual item is the virtual shield, the prompt information may indicate a defense power value of the virtual shield.

In addition, in the embodiments of this application, operations such as a click and a long press on the virtual chess pieces or the virtual items are merely exemplary descriptions. The operations may alternatively be box selection, swiping, or the like. This is not limited in this application.

Operation 230: Display, in response to an operation of equipping M virtual items in the selected state to a first virtual chess piece of the at least one virtual chess piece, a display effect of the first virtual chess piece being equipped with the M virtual items.

M is greater than 1 and less than and equal to N, that is, the virtual items in the selected state may be all or some virtual items of the to-be-equipped virtual items displayed in operation 210. Using being some virtual items as an example, if there are three to-be-equipped virtual items, the virtual items in the selected state may be two of them.

The first virtual chess piece is any one of the at least one virtual chess piece displayed on the game interface described above.

In some embodiments, in response to an operation of dragging the M virtual items in the selected state to the first virtual chess piece, the display effect of the first virtual chess piece being equipped with the M virtual items is displayed.

In some embodiments, the display effect may be displaying icons of the M virtual items in a surrounding area of the first virtual chess piece, the surrounding area of the first virtual chess piece being an area whose distance to the first virtual chess piece is less than a preset threshold. The preset threshold is a preset distance value, for example, may be 50 pixels, or may be 1 centimeter. For example, referring to FIG. 6 and FIG. 8, in FIG. 6, the virtual sword 41 and the virtual shield 42 in the selected state may be dragged to a virtual chess piece A, to obtain a display effect shown in FIG. 8. That is, the virtual sword 41 and the virtual shield 42 are displayed above the virtual chess piece A after being reduced in size.

According to the foregoing method, a plurality of virtual items can be equipped through one drag operation, thereby improving the operation efficiency.

In some embodiments, the at least two virtual items may alternatively be equipped to the first virtual chess piece through an operation of clicking or long-pressing the first virtual chess piece. A specific operation of equipping the virtual item to the virtual chess piece is not limited in this application.

In addition, when only one virtual item in the selected state exists, the virtual item may also be equipped in the foregoing method.

According to the technical solutions provided in the embodiments of this application, the at least one virtual chess piece and N to-be-equipped virtual items are displayed in the game interface of the auto chess game, the virtual items in the selected state and the virtual items in the unselected state among the virtual items are differentially displayed in the item multi-option mode, and in response to the operation of equipping M virtual items in the selected state to any virtual chess piece, the virtual chess piece being equipped with the M virtual items is displayed. The plurality of virtual items can be equipped to the virtual chess piece through one equipping operation, thereby reducing operation steps, and improving the efficiency of equipping the virtual items.

In the foregoing embodiments, only selection and equipping of the virtual items in this application are described. In the following embodiments, while equipping of the virtual item is further described, combination and transfer of the virtual items are also described.

In some embodiments, when P virtual items in the selected state can be combined into a second virtual item, the second virtual item is displayed, and the second virtual item is in the selected state.

P is greater than 1 and less than and equal to M, that is, the virtual items configured for combining the second virtual item may be all or some virtual items of the virtual items in the selected state in operation 220. Using being some virtual items as an example, if there are three virtual items in the selected state, the virtual items configured for combining the second virtual item may be two of them.

For example, in the item multi-option mode, after the P virtual items are combined into the second virtual item, the P virtual items may continue to be displayed, and the second virtual item is displayed in a surrounding area of the P virtual items. Further, connection lines between the second virtual item and the P virtual items may also be displayed, to represent a combination relationship between them. In addition, the display of the P virtual items may also be canceled, and the second virtual item is displayed in an area in which the P virtual items are originally located. How to display the second virtual item is not limited in this application.

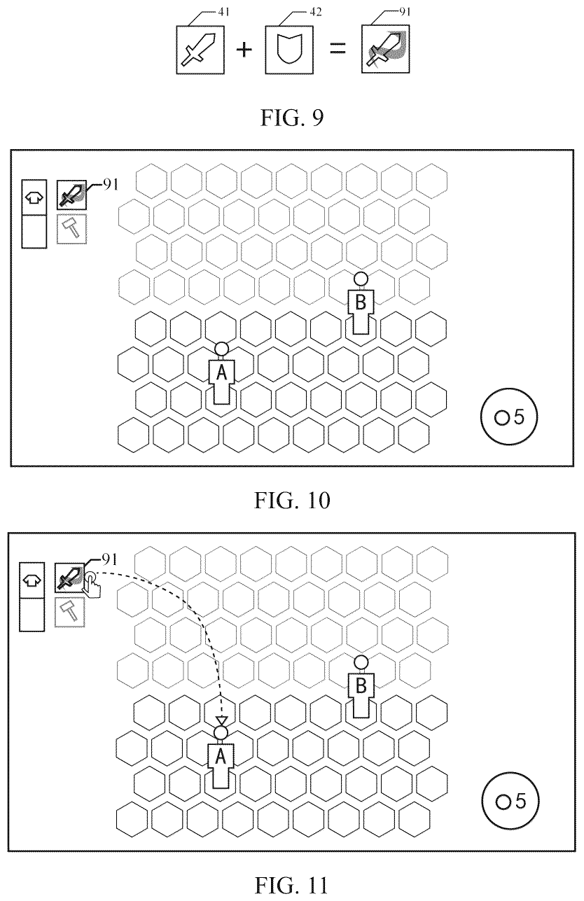

The second virtual item is a combined item of the P virtual items. The P virtual items may include two or more virtual items. The P virtual items can be combined into the second virtual item, meaning that the at least two virtual items have a combination rule for being combined into the second virtual item, the combination rule being preset in the game by technicians. For example, referring to FIG. 9, in some embodiments, the virtual sword 41 and the virtual shield 42 can be combined into a virtual greatsword 91.

When the virtual sword 41 and the virtual shield 42 can be combined into the virtual greatsword 91, for example, referring to FIG. 5 and FIG. 10, in FIG. 5, the virtual sword 41 has already been in the selected state. In this case, in response to a click operation on the virtual shield 42 in the unselected state, the virtual shield 42 may be converted from the unselected state to the selected state. In addition, as shown in FIG. 10, the combined virtual greatsword 91 in the selected state is displayed.

In an adaptation status between the virtual items in the selected state and the item combination rule, the currently combinable second virtual item is displayed, so that the current combination status of the virtual items can be intuitively reflected, providing effective assistance for game strategy planning of the user.

In this application, in the item multi-option mode, combination performed on the virtual items is a pre-combination. The pre-combination is a combination that can be canceled through subsequent operations. This is further described in the following embodiments.

According to the foregoing method, the virtual items may be combined while virtual items that need to be equipped are selected in the item multi-option mode, thereby improving the operation efficiency.

In some embodiments, the virtual items in the selected state are combined based on the order of entering the selected state.

Whether the virtual items are in the selected state is determined by an operation performed on the virtual items by the user. Therefore, the order in which the virtual items enter the selected state is the order in which the user performs the corresponding operation on the virtual items. This is described below by using an example.

For example, if in the item multi-option mode, the selection states of the virtual items can be converted by clicking, no virtual item in the selected state exists, and a virtual item A, a virtual item B, a virtual item C, and a virtual item D in the unselected state exist, where the virtual item A and the virtual item B can be combined into a virtual item E, and the virtual item C and the virtual item D can be combined into a virtual item F, when the virtual item A, the virtual item B, the virtual item C, and the virtual item D are clicked in sequence, the virtual item E and the virtual item F in the selected state are displayed in sequence; when the virtual item D, the virtual item C, the virtual item B, and the virtual item A are clicked in sequence, the virtual item F and the virtual item E are displayed in sequence; and when the virtual item A, the virtual item C, the virtual item D, and the virtual item B are clicked in sequence, the virtual item F and the virtual item E are displayed in sequence.

According to the foregoing method, the plurality of virtual items may be combined in sequence based on an operation sequence in the item multi-option mode, and the user may control, by controlling the operation sequence, which virtual items need to be specifically combined, thereby improving the item combination efficiency.

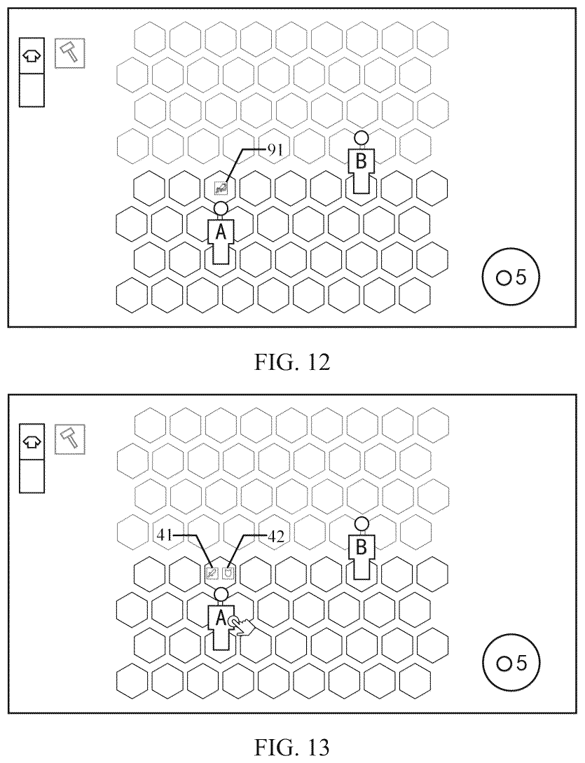

In addition, because the combined second virtual item is in the selected state, the combined second virtual item may also be equipped to the virtual chess piece according to the method in operation 230. For example, referring to FIG. 11 and FIG. 12, in FIG. 11, the virtual greatsword 91 in the selected state may be dragged to the virtual chess piece A, to obtain a display effect shown in FIG. 12. That is, the virtual greatsword 91 is displayed above the virtual chess piece A after being reduced in size. In addition, when both a combined virtual item and an uncombined virtual item in the selected state exist, the combined virtual item and the uncombined virtual item may also be simultaneously equipped to the virtual chess piece using the foregoing method.

In some embodiments, when the second virtual item is not equipped on any one of the at least one virtual chess piece, the display of the second virtual item is canceled in response to a combination cancel operation on the second virtual item, and P virtual items combining the second virtual item are displayed.

For example, the combination cancel operation on the second virtual item may be a corresponding operation performed on the P virtual items combining the second virtual item, for example, switching any one of the P virtual items from the selected state to the unselected state, or may be a click operation or a long-press operation directly performed on the second virtual item. This is not limited in this application.

In the item multi-option mode, when the plurality of virtual items are combined, combination cancel may be selectively performed using the foregoing method, thereby improving the flexibility of combining the virtual items.

In some embodiments, when at least one virtual item in the selected state and at least one virtual item in the unselected state are combinable into a seventh virtual item, combination prompt information corresponding to the seventh virtual item is displayed. The seventh virtual item is a virtual item that can be combined by the at least one virtual item in the selected state and the at least one virtual item in the unselected state in the game interface. In the game interface, a plurality of virtual items in the unselected state that can be combined with the virtual items in the selected state into different virtual items may exist. In this case, the game interface displays combination prompt information corresponding to the plurality of different virtual items. The combination prompt information may be text information configured for prompting the combinable virtual item, or may be a direct display of the combinable virtual item. For example, if a virtual item A, a virtual item B, and a virtual item C in the unselected state exist in the game interface, the virtual item A and the virtual item B can be combined into a virtual item D, and the virtual item A and the virtual item C can be combined into a virtual item E, when the virtual item A is switched to the selected state, the virtual item D is displayed in a surrounding area of the virtual item B, and the virtual item E is displayed in a surrounding area of the virtual item C in the game interface.

According to the foregoing method, before the virtual items are combined, the combinable virtual items can be prompted based on the virtual items already owned by the user and the virtual items selected by the user, which further improves the item combination efficiency, avoids the need for the user to memorize the item combination rule, and reduces the operation difficulty of the user.

In some embodiments, after operation 230, the foregoing virtual item equipping method further includes: displaying, in response to an operation of equipping a fifth virtual item to the first virtual chess piece, a display effect of the first virtual chess piece being equipped with the fifth virtual item and the M virtual items.

The fifth virtual item is any one of the to-be-equipped virtual items other than the M virtual items. For example, the operation of equipping the fifth virtual item to the first virtual chess piece may be dragging the fifth virtual item to an area in which the first virtual chess piece is located.

In some embodiments, after operation 230, the foregoing virtual item equipping method further includes: displaying, in response to an operation of replacing a sixth virtual item in the M virtual items with a fifth virtual item, a display effect of the first virtual chess piece being equipped with the fifth virtual item and virtual items in the M virtual items other than the sixth virtual item.

The sixth virtual item is any one of the M virtual items.

For example, if the M virtual items are displayed on a corresponding area of the first virtual chess piece, the operation of replacing a sixth virtual item in the M virtual items with a fifth virtual item may be dragging the fifth virtual item to an area in which the sixth virtual item is located.

In some embodiments, after operation 230, the foregoing virtual item equipping method further includes: displaying, in response to an operation of removing a sixth virtual item in the M virtual items, a display effect of the first virtual chess piece being equipped with virtual items in the M virtual items other than the sixth virtual item.

For example, if the M virtual items are displayed in a corresponding area of the first virtual chess piece, the operation of removing a sixth virtual item in the M virtual items may be a click operation or a swipe operation on the area in which the sixth virtual item is located.

According to the foregoing method, the virtual items that have been equipped may be added, replaced, or removed, thereby improving the flexibility and tolerance of equipping the virtual items.

In some embodiments, in response to the operation of equipping the M virtual items in the selected state to the first virtual chess piece in the at least one virtual chess piece, the M virtual items and virtual items in the to-be-equipped virtual items other than the M virtual items are differentially displayed.

For example, in the item multi-option mode, when the virtual items in the selected state are displayed in the first display style, and the virtual items in the unselected state are displayed in the second display style, the M virtual items that have been equipped may be displayed, in a third display style different from both the first display style and the second display style, in an area in which the M virtual items are located before being equipped. In addition, in the foregoing embodiment, the operation of removing a sixth virtual item in the M virtual items may be a corresponding operation performed on the sixth virtual item displayed in the third display style. For example, the sixth virtual item may be removed by clicking the sixth virtual item displayed in the third display style.

In the related art, after the virtual item is equipped, the display of the equipped virtual item is canceled in an area in which the equipped virtual item is originally located. In the foregoing method, the virtual item that has been equipped can be clearly and intuitively reflected by differentially displaying the virtual item in an area in which the virtual item is located before being equipped. In addition, in the item multi-option mode, if the plurality of virtual items are equipped to the plurality of virtual chess pieces, corresponding operations may be directly performed in an area in which the plurality of virtual items are located before being equipped to remove the items, thereby improving the operation efficiency.

In some embodiments, in response to an exit operation on the item multi-option mode, the item multi-option mode may be exited. For example, the exit operation on the item multi-option mode may be a click operation on a blank area in the game interface. In some embodiments, the blank area in the game interface is all areas in the game interface except an area in which the virtual items are located, or is a match display area in the game interface. For example, after the item multi-option mode is exited, all virtual items displayed in the first display style are switched to the second display style, and the display of all unequipped second virtual items is canceled.

In some embodiments, the virtual item equipping method provided in this application may further include the following operations:
1. Enter an item transfer mode in response to a second operation on the first virtual chess piece, the second operation being an operation for triggering to enter the item transfer mode.

The item transfer mode is a mode in which the user may transfer items between virtual chess pieces.

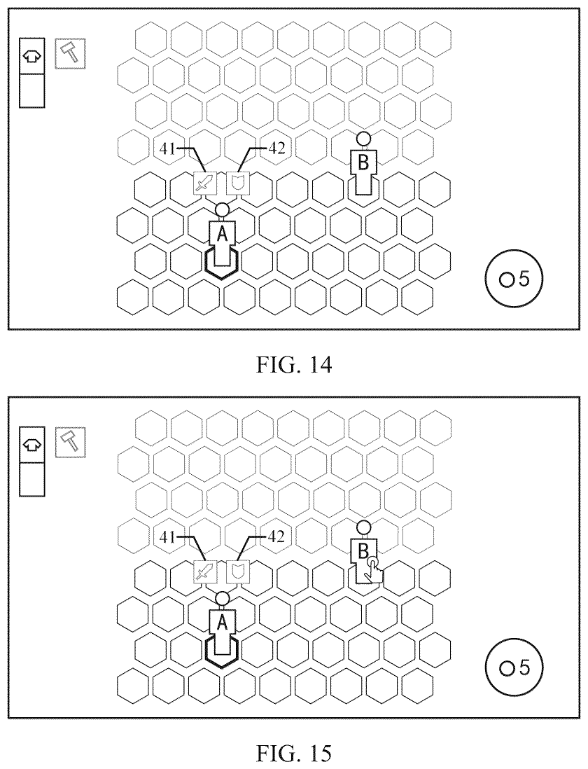

In some embodiments, the second operation may be a long-press operation on the first virtual chess piece. For example, referring to FIG. 13 and FIG. 14, in FIG. 13, in response to a long-press operation on the virtual chess piece A, the item multi-option mode may be entered, and display forms of the virtual chess piece A and the virtual sword 41 and the virtual shield 42 that are equipped on the virtual chess piece A are switched to a display form shown in FIG. 14. That is, the virtual chess piece A is marked for display, and the virtual sword 41 and the virtual shield 42 that are equipped on the virtual chess piece A are enlarged for display.
2. In the item transfer mode, in response to an operation of selecting a second virtual chess piece, virtual items equipped on the first virtual chess piece are transferred to the second virtual chess piece for equipping.

The second virtual chess piece is any virtual chess piece in the at least one virtual chess piece other than the first virtual chess piece.

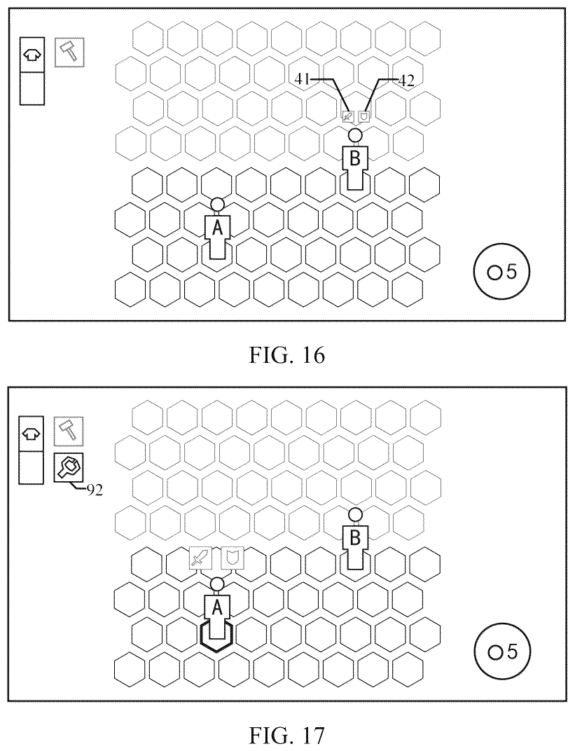

In some embodiments, the operation of selecting a second virtual chess piece may be a click operation on the second virtual chess piece. For example, referring to FIG. 15 and FIG. 16, in FIG. 15, in the item transfer mode, the virtual chess piece A has been marked for display, and the virtual sword 41 and the virtual shield 42 that are equipped on the virtual chess piece A have also been enlarged for display. In this case, in response to a click operation on a virtual chess piece B, as shown in FIG. 16, the virtual sword 41 and the virtual shield 42 may be transferred to the virtual chess piece B.

According to the foregoing method, one-time overall transfer of a plurality of items between virtual chess pieces can be achieved, thereby improving the item transfer efficiency.

In some embodiments, in the item transfer mode, in response to an operation of transferring a third virtual item equipped on the first virtual chess piece to the second virtual chess piece, the third virtual item is transferred to the second virtual chess piece for equipping. The third virtual item is any virtual item equipped on the first virtual chess piece.

When the first virtual chess piece is equipped with only the third virtual item, for a specific operation of transferring the third virtual item to the second virtual chess piece, reference may be made to the operation of transferring the at least two virtual items in the foregoing embodiment.

When the first virtual chess piece is equipped with the plurality of virtual items, for example, referring to FIG. 14, in the item transfer mode, the enlarged virtual sword 41 may be clicked first, and then the virtual chess piece B is clicked, to transfer the virtual sword 41 from the virtual chess piece A to the virtual chess piece B.

When the first virtual chess piece is equipped with a plurality of virtual items including the third virtual item, one virtual item (that is, the third virtual item) equipped on the first virtual chess piece may also be independently transferred to the second virtual chess piece through the foregoing operation.

According to the foregoing method, transfer of a single item between virtual chess pieces can be achieved, thereby improving the flexibility of item transfer.

In some embodiments, when the virtual items equipped on the first virtual chess piece are transferred to the second virtual chess piece for equipping, when the virtual items transferred to the second virtual chess piece and the virtual items that have been equipped on the second virtual chess piece are combinable into a fourth virtual item, a display effect of the second virtual chess piece being equipped with the fourth virtual item is displayed.

The fourth virtual item is a virtual item that can be combined by the virtual items (some or all) transferred from the first virtual chess piece and the virtual items equipped on the second virtual chess piece.

For example, when the virtual sword and the virtual shield can be combined into the virtual greatsword, and both the virtual sword and the virtual shield cannot be combined with the virtual hammer, if the virtual chess piece A is equipped with the virtual sword and the virtual hammer, and the virtual chess piece B is equipped with the virtual shield, and if the virtual items equipped on the virtual chess piece A are transferred to the virtual chess piece B, the virtual chess piece B being equipped with the virtual greatsword and the virtual hammer is displayed.

According to the foregoing method, virtual items can be combined while item transfer is performed between virtual chess pieces, thereby improving the operation efficiency.

In some embodiments, when a condition required for item transfer is satisfied, the operation of transferring the virtual items equipped on the first virtual chess piece to the second virtual chess piece for equipping is performed, or when a condition required for item transfer is not satisfied, transferring the virtual items equipped on the first virtual chess piece to the second virtual chess piece is skipped, and prompt information is displayed, the prompt information indicating the condition required for the item transfer.

The prompt information may be displayed as a pop-up window, or as a locked display for the at least two virtual items, such as adding a red border to the at least two virtual items.

Referring to FIG. 17, in some embodiments, the condition required for item transfer may be that the user owns a virtual detacher 92.

For example, when the user owns at least one virtual detacher, in response to one item transfer operation, the display of one virtual detacher is canceled, that is, the virtual detacher is consumed; and when the user does not own the virtual detacher, in response to an item transfer operation, a pop-up window pops up on the game interface, to prompt the user that the user does not own the virtual detacher.

In some embodiments, the condition required for the item transfer may further be that after the item transfer is performed, a quantity of virtual items equipped on the second virtual chess piece does not exceed a maximum quantity of items allowed to be equipped on the second virtual chess piece. The maximum quantity of items may be preset by technicians.

For example, when the maximum quantity of items is 2, if the virtual chess piece A is equipped with one virtual item and the virtual chess piece B is equipped with one virtual item, the virtual item equipped on the virtual chess piece A can be normally transferred to the virtual chess piece B; and if the virtual chess piece A is equipped with two virtual items, and the virtual chess piece B is equipped with one virtual item, in response to an operation of transferring the virtual items equipped on the virtual chess piece A to the virtual chess piece B, the pop-up window pops up on the game interface to prompt that after item transfer is performed, a quantity of virtual items equipped on the virtual chess piece B exceeds the maximum quantity of items.

In some embodiments, the condition required for item transfer may alternatively be that the first virtual chess piece is equipped with at least one virtual item. For example, when the first virtual chess piece is not equipped with any virtual item, in response to an operation of performing item transfer on the first virtual chess piece, the pop-up window pops up on the game interface to prompt that the first virtual chess piece is not equipped with any virtual item.

It can be learned that during virtual item transfer, a transfer behavior is controlled based on a transfer condition, and the virtual item transfer is blocked and a prompt is provided when the condition is not satisfied, thereby effectively ensuring the correctness of the virtual item transfer. In addition, the user can be prompted when transfer is impossible, thereby promoting the use of the virtual item transfer.

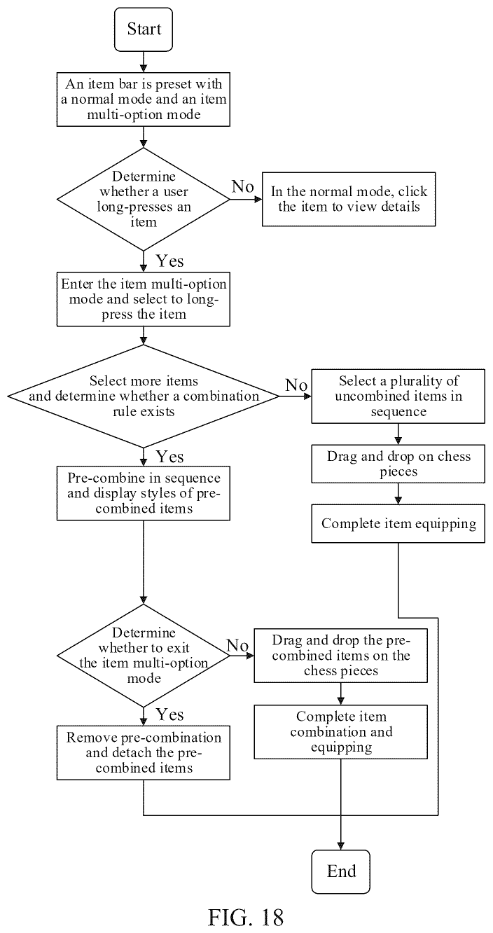

FIG. 18 is a block diagram of a specific solution for item equipping in an item multi-option mode according to an embodiment of this application.

In this solution, the virtual items are displayed in an item bar in the game interface, and the item bar has two preset modes, a normal mode and an item multi-option mode. The item bar is initially in the normal mode. In this case, the user may click virtual items in the item bar to view their attribute details. When the user long-presses a virtual item in the item bar, the item multi-option mode is entered, and the long-pressed virtual item is selected. Then, the user may select more virtual items in the item bar in sequence. In this process, if the selected virtual items have a combination rule, the selected virtual items are pre-combined in sequence, and styles of items pre-combined by the selected virtual items are displayed, and if the selected virtual items do not have the combination rule, the user may drag and drop the selected items on the virtual chess pieces to complete equipping of the virtual items. In addition, in the item multi-option mode, the pre-combined items may also be dragged to the virtual chess pieces. In this case, it may be considered that a combination operation on the virtual items is completed. In addition, when the item multi-option mode is exited, if a pre-combined item that is not equipped to a virtual chess piece exists, pre-combination of the item is removed, and the pre-combined item is disassembled.

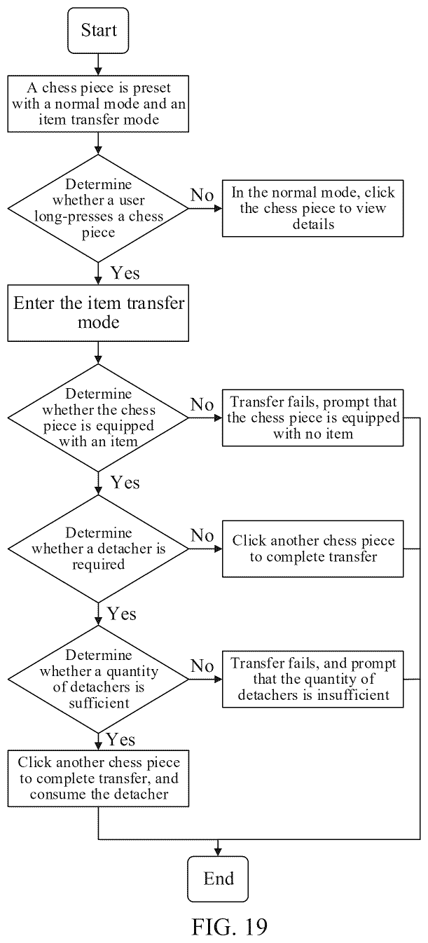

FIG. 19 is a block diagram of a specific solution for item transfer between virtual chess pieces in an item transfer mode according to an embodiment of this application.

In this solution, the virtual chess pieces have two preset modes: a normal mode and an item transfer mode. The virtual chess pieces are initially in the normal mode. In this case, the user may view details of the virtual chess pieces (including categories, attribute details, and the like of the virtual chess pieces) by clicking the virtual chess pieces. When the user long-presses a virtual chess piece, the item transfer mode is entered. In this case, the client determines, based on whether the long-pressed virtual chess piece is equipped with a virtual item, whether a virtual detacher is required for item transfer, and whether a quantity of virtual detachers is sufficient, whether the virtual item equipped on the long-pressed virtual chess piece can be transferred to another virtual chess piece. If the virtual item can be transferred to another virtual chess piece, another chess piece can be clicked to complete transfer, and if the virtual item cannot be transferred, a reason for a transfer failure is prompted.

The following is an apparatus embodiment of this application, which can be used to perform the method embodiments of this application. For details not disclosed in the apparatus embodiment of this application, reference is made to the method embodiments of this application.

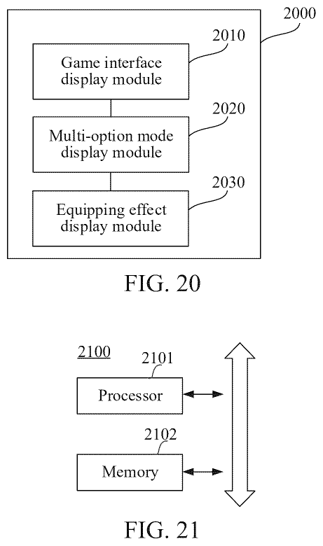

FIG. 20 is a block diagram of a virtual item equipping apparatus according to an embodiment of this application. The apparatus has a function of implementing the foregoing virtual item equipping method, and the function may be implemented by hardware, or may be implemented by hardware executing corresponding software. The apparatus may be arranged in the foregoing computer device. The apparatus 2000 may include: a game interface display module 2010, a multi-option mode display module 2020, and an equipping effect display module 2030.

The game interface display module 2010 is configured to display at least one virtual chess piece and N to-be-equipped virtual items in a game interface of an auto chess game, N being greater than 1.

The multi-option mode display module 2020 is configured to differentially display, in an item multi-option mode, virtual items in a selected state and virtual items in an unselected state among the N to-be-equipped virtual items.

The equipping effect display module 2030 is configured to: display, in response to an operation of equipping M virtual items in the selected state to a first virtual chess piece of the at least one virtual chess piece, a display effect of the first virtual chess piece being equipped with the M virtual items, M being greater than 1 and less than and equal to N.

In some embodiments, the multi-option mode display module 2020 is further configured to: display, in the item multi-option mode, the virtual items in the selected state in a first display style, and display the virtual items in the unselected state in a second display style, the first display style being different from the second display style.

In some embodiments, the multi-option mode display module 2020 is further configured to: switch, in response to an operation on any virtual item in the unselected state, the operated virtual item from the second display style to the first display style; or switch, in response to an operation on any virtual item in the selected state, the operated virtual item from the first display style to the second display style.

In some embodiments, the multi-option mode display module 2020 is further configured to: enter the item multi-option mode in response to a first operation on a first virtual item, and display the first virtual item in the first display style, the first virtual item being any to-be-equipped virtual item, and the first operation being an operation configured for triggering to enter the item multi-option mode.

In some embodiments, the equipping effect display module 2030 is further configured to display, in response to an operation of dragging the M virtual items in the selected state to the first virtual chess piece, the display effect of the first virtual chess piece being equipped with the M virtual items.

In some embodiments, the apparatus 2000 further includes: a combined item display module (not shown in FIG. 20).

The combined item display module is configured to: when P virtual items in the selected state are combinable into a second virtual item, display the second virtual item, the second virtual item being in the selected state, and P being greater than 1 and less than and equal to M.

In some embodiments, the combined item display module is further configured to: when the second virtual item is not equipped on any one of the at least one virtual chess piece, cancel the display of the second virtual item in response to a combination cancel operation on the second virtual item, and display the P virtual items configured for combining the second virtual item.

In some embodiments, the virtual items in the selected state are combined based on the order of entering the selected state.

In some embodiments, the apparatus 2000 further includes: an item transfer display module (not shown in FIG. 20).

The item transfer display module is configured to enter an item transfer mode in response to a second operation on the first virtual chess piece, the second operation being an operation configured for triggering to enter the item transfer mode.

The item transfer display module is further configured to: transfer, in the item transfer mode, in response to an operation of selecting a second virtual chess piece, the virtual items equipped on the first virtual chess piece to the second virtual chess piece for equipping.

In some embodiments, the item transfer display module is further configured to transfer, in the item transfer mode in response to an operation of transferring a third virtual item equipped on the first virtual chess piece to the second virtual chess piece, the third virtual item to the second virtual chess piece for equipping, the third virtual item being any virtual item equipped on the first virtual chess piece.

In some embodiments, the item transfer display module is further configured to: when the virtual item transferred to the second virtual chess piece and the virtual items that have been equipped on the second virtual chess piece are combinable into a fourth virtual item, display a display effect of the second virtual chess piece being equipped with the fourth virtual item.

In some embodiments, the item transfer display module is further configured to: when a condition required for item transfer is satisfied, perform an operation of transferring the virtual items equipped on the first virtual chess piece to the second virtual chess piece for equipping; or when a condition required for item transfer is not satisfied, skip transferring the virtual items equipped on the first virtual chess piece to the second virtual chess piece, and display prompt information, the prompt information indicating the condition required for item transfer.

In some embodiments, the apparatus 2000 further includes: a display effect change module (not shown in FIG. 20).

The display effect change module is configured to: display, in response to an operation of equipping a fifth virtual item to the first virtual chess piece, a display effect of the first virtual chess piece being equipped with the fifth virtual item and the M virtual items; or display, in response to an operation of replacing a sixth virtual item in the M virtual items with a fifth virtual item, a display effect of the first virtual chess piece being equipped with the fifth virtual item and virtual items in the M virtual items other than the sixth virtual item; or display, in response to an operation of removing a sixth virtual item in the M virtual items, a display effect of the first virtual chess piece being equipped with virtual items in the M virtual items other than the sixth virtual item.

In some embodiments, the apparatus 2000 further includes: a combined information prompt module (not shown in FIG. 20).

The combined information prompt module is configured to: when at least one virtual item in the selected state and at least one virtual item in the unselected state are combinable into a seventh virtual item, display combination prompt information corresponding to the seventh virtual item.

When the apparatus provided in the foregoing embodiments implements functions of the apparatus, only the division of the foregoing functional modules is used as an example for description. During actual application, the foregoing function allocation is completed by different functional modules according to needs, that is, the internal structure of the device is divided into different functional modules, to complete all or some of functions described above. In addition, the apparatus and method embodiments provided in the foregoing embodiments belong to the same conception. For a specific implementation process, refer to the method embodiment, and details are not described herein again.

FIG. 21 is a block diagram of a structure of a terminal device according to an embodiment of this application.

Generally, the terminal device 2100 includes: a processor 2101 and a memory 2102.

The processor 2101 may include one or more processing cores, such as a 4-core processor or a 14-core processor. The processor 2101 may be implemented by using at least one hardware form of a digital signal processing (DSP), a field programmable gate array (FPGA), and a programmable logic array (PLA). The processor 2101 may also include a main processor and a coprocessor. The main processor is a processor configured to process data in an active state, also referred to as a central processing unit (CPU). The coprocessor is a low-power consumption processor configured to process data in a standby state. In some embodiments, the processor 2101 may be integrated with a graphics processing unit (GPU). The GPU is configured to be responsible for rendering and drawing content that needs to be displayed on a display screen. In some embodiments, the processor 2101 may also include an AI processor. The AI processor is configured to process a computing operation related to machine learning.

The memory 2102 may include one or more computer-readable storage media. The computer-readable storage medium may be tangible and non-transitory. The memory 2102 may further include a high-speed random access memory and a non-volatile memory, for example, one or more disk storage devices and flash storage devices. In some embodiments, the non-transitory computer-readable storage medium in the memory 2102 has a computer program stored therein, and the computer program is loaded and executed by the processor 2101 to implement the foregoing virtual item equipping method.

A person skilled in the art may understand that the structure shown in FIG. 21 constitutes no limitation to the terminal device 2100, and the terminal device may include more or fewer components than those shown in the figure, or some components may be combined, or a different component arrangement may be used.

In some embodiments, a non-transitory computer-readable storage medium is provided. The storage medium has a computer program stored therein, the computer program being loaded and executed by a processor to implement the foregoing virtual item equipping method.

In some embodiments, the computer-readable storage medium may include: a read-only memory (ROM), a random access memory (RAM), a solid state drives (SSD), an optical disc, or the like. The RAM may include a resistance random access memory (ReRAM) and a dynamic random access memory (DRAM).

In some embodiments, a computer program product is provided. The computer program product includes a computer program, the computer program being stored in a non-transitory computer-readable storage medium, a processor reading the computer program from the computer-readable storage medium, and executing the computer program, to implement the foregoing virtual item equipping method.

“A plurality of” mentioned in this specification means two or more. “And/or” describes an association relationship between associated objects and represents that three relationships may exist. For example, A and/or B may represent the following three cases: Only A exists, both A and B exist, and only B exists. The character “/” generally represents an “or” relationship between the associated objects. In addition, the operation numbers described in this specification merely schematically show a possible execution sequence of the operations. In some other embodiments, the operations may not be performed based on the number sequence. For example, two operations with different numbers may be performed simultaneously, or two operations with different numbers may be performed based on the order contrary to the sequence shown in the figure. This is not limited in the embodiments of this application.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely examples of the embodiments of this application, but are not intended to limit this application. Any modification, equivalent replacement, or improvement made within the spirit and principle of this application shall fall within the protection scope of this application.

What is claimed is:

1. A virtual item equipping method performed by a computer device, the method comprising:
displaying at least one virtual chess piece and N to-be-equipped virtual items in a game interface of an auto chess game, N being greater than 1;
displaying, in an item multi-option mode, virtual items in a selected state and virtual items in an unselected state among the N to-be-equipped virtual items; and
in response to an operation of equipping M virtual items in the selected state to a first virtual chess piece of the at least one virtual chess piece, displaying a display effect of the first virtual chess piece being equipped with the M virtual items, M being greater than 1 and less than and equal to N.

2. The method according to claim 1, wherein the displaying, in an item multi-option mode, virtual items in a selected state and virtual items in an unselected state among the N to-be-equipped virtual items comprises:
displaying, in the item multi-option mode, the virtual items in the selected state in a first display style, and displaying the virtual items in the unselected state in a second display style, the first display style being different from the second display style.

3. The method according to claim 2, further comprising:
switching, in response to an operation on any virtual item in the unselected state, the operated virtual item from the second display style to the first display style; and
switching, in response to an operation on any virtual item in the selected state, the operated virtual item from the first display style to the second display style.

4. The method according to claim 1, wherein the displaying a display effect of the first virtual chess piece being equipped with the M virtual items comprises:
displaying, in response to an operation of dragging the M virtual items in the selected state to the first virtual chess piece, the display effect of the first virtual chess piece being equipped with the M virtual items.

5. The method according to claim 1, further comprising:
when P virtual items in the selected state are combinable into a second virtual item, displaying the second virtual item, the second virtual item being in the selected state, and P being greater than 1 and less than and equal to M.

6. The method according to claim 1, further comprising:
entering an item transfer mode in response to a second operation on the first virtual chess piece, the second operation being an operation configured for triggering to enter the item transfer mode; and
in the item transfer mode in response to an operation of selecting a second virtual chess piece, transferring the virtual items equipped on the first virtual chess piece to the second virtual chess piece for equipping.

7. The method according to claim 1, wherein after the displaying a display effect of the first virtual chess piece being equipped with the M virtual items, the method further comprises:
displaying, in response to an operation of equipping a fifth virtual item to the first virtual chess piece, a display effect of the first virtual chess piece being equipped with the fifth virtual item and the M virtual items;
displaying, in response to an operation of replacing a sixth virtual item in the M virtual items with a fifth virtual item, a display effect of the first virtual chess piece being equipped with the fifth virtual item and virtual items in the M virtual items other than the sixth virtual item; and
displaying, in response to an operation of removing a sixth virtual item in the M virtual items, a display effect of the first virtual chess piece being equipped with virtual items in the M virtual items other than the sixth virtual item.

8. The method according to claim 1, further comprising:
when at least one virtual item in the selected state and at least one virtual item in the unselected state are combinable into a seventh virtual item, displaying combination prompt information corresponding to the seventh virtual item.

9. A computer device, comprising a processor and a memory, the memory having a computer program stored therein, the computer program being loaded and executed by the processor and causing the computer device to implement a virtual item equipping method including:
displaying at least one virtual chess piece and N to-be-equipped virtual items in a game interface of an auto chess game, N being greater than 1;
displaying, in an item multi-option mode, virtual items in a selected state and virtual items in an unselected state among the N to-be-equipped virtual items; and
in response to an operation of equipping M virtual items in the selected state to a first virtual chess piece of the at least one virtual chess piece, displaying a display effect of the first virtual chess piece being equipped with the M virtual items, M being greater than 1 and less than and equal to N.

10. The computer device according to claim 9, wherein the displaying, in an item multi-option mode, virtual items in a selected state and virtual items in an unselected state among the N to-be-equipped virtual items comprises:
displaying, in the item multi-option mode, the virtual items in the selected state in a first display style, and displaying the virtual items in the unselected state in a second display style, the first display style being different from the second display style.

11. The computer device according to claim 10, wherein the method further comprises:
switching, in response to an operation on any virtual item in the unselected state, the operated virtual item from the second display style to the first display style; and
switching, in response to an operation on any virtual item in the selected state, the operated virtual item from the first display style to the second display style.

12. The computer device according to claim 9, wherein the displaying a display effect of the first virtual chess piece being equipped with the M virtual items comprises:
displaying, in response to an operation of dragging the M virtual items in the selected state to the first virtual chess piece, the display effect of the first virtual chess piece being equipped with the M virtual items.

13. The computer device according to claim 9, wherein the method further comprises:
when P virtual items in the selected state are combinable into a second virtual item, displaying the second virtual item, the second virtual item being in the selected state, and P being greater than 1 and less than and equal to M.

14. The computer device according to claim 9, wherein the method further comprises:
entering an item transfer mode in response to a second operation on the first virtual chess piece, the second operation being an operation configured for triggering to enter the item transfer mode; and
in the item transfer mode in response to an operation of selecting a second virtual chess piece, transferring the virtual items equipped on the first virtual chess piece to the second virtual chess piece for equipping.

15. The computer device according to claim 9, wherein after the displaying a display effect of the first virtual chess piece being equipped with the M virtual items, the method further comprises:
displaying, in response to an operation of equipping a fifth virtual item to the first virtual chess piece, a display effect of the first virtual chess piece being equipped with the fifth virtual item and the M virtual items;
displaying, in response to an operation of replacing a sixth virtual item in the M virtual items with a fifth virtual item, a display effect of the first virtual chess piece being equipped with the fifth virtual item and virtual items in the M virtual items other than the sixth virtual item; and
displaying, in response to an operation of removing a sixth virtual item in the M virtual items, a display effect of the first virtual chess piece being equipped with virtual items in the M virtual items other than the sixth virtual item.

16. The computer device according to claim 9, wherein the method further comprises:
when at least one virtual item in the selected state and at least one virtual item in the unselected state are combinable into a seventh virtual item, displaying combination prompt information corresponding to the seventh virtual item.

17. A non-transitory computer-readable storage medium having a computer program stored therein, and the computer program being loaded and executed by a processor of a computer device and causing the computer device to implement a virtual item equipping method including:
displaying at least one virtual chess piece and N to-be-equipped virtual items in a game interface of an auto chess game, N being greater than 1;
displaying, in an item multi-option mode, virtual items in a selected state and virtual items in an unselected state among the N to-be-equipped virtual items; and
in response to an operation of equipping M virtual items in the selected state to a first virtual chess piece of the at least one virtual chess piece, displaying a display effect of the first virtual chess piece being equipped with the M virtual items, M being greater than 1 and less than and equal to N.

18. The non-transitory computer-readable storage medium according to claim 17, wherein the displaying, in an item multi-option mode, virtual items in a selected state and virtual items in an unselected state among the N to-be-equipped virtual items comprises:
displaying, in the item multi-option mode, the virtual items in the selected state in a first display style, and displaying the virtual items in the unselected state in a second display style, the first display style being different from the second display style.

19. The non-transitory computer-readable storage medium according to claim 17, wherein the displaying a display effect of the first virtual chess piece being equipped with the M virtual items comprises:
displaying, in response to an operation of dragging the M virtual items in the selected state to the first virtual chess piece, the display effect of the first virtual chess piece being equipped with the M virtual items.

20. The non-transitory computer-readable storage medium according to claim 17, wherein the method further comprises:
when P virtual items in the selected state are combinable into a second virtual item, displaying the second virtual item, the second virtual item being in the selected state, and P being greater than 1 and less than and equal to M.
